(19) United States
(12) Patent Application Publication
(10) Pub. No.: US 2012/0299421 A1
(43) Pub. Date: Nov. 29, 2012

(54) ELECTRODYNAMIC ENGINE WITH A THREE-POINT SUSPENDED SHAFT AND USAGE OF A THIRD BEARING AS AN ASSISTING SHAFT MOUNT

(75) Inventors: Timo WEHLEN, Friedrichshafen (DE); Karl-Hermann KETTELER, Markdorf (DE); Stephan SCHARR, Friedrichshafen (DE)

(73) Assignee: ZF FRIEDRICHSHAFEN AG, Friedrichshafen (DE)

(21) Appl. No.: 13/466,289

(22) Filed: May 8, 2012

(30) Foreign Application Priority Data
May 26, 2011 (DE) 10 2011 076 524.7

(51) Int. Cl. H02K 7/08

(52) U.S. Cl. 310/90

(57) ABSTRACT

The electro dynamic machine (1) has a rotatable supported shaft (4) and first and second axial main bearings (6, 7), spaced from one another, which facilitate rotation of the shaft (4). In addition, a third bearing (8) is provided which is designed to at least absorb radial forces created by the shaft (4). A dimensioning is provided for a maximum rotational speed of the shaft (4), and this maximum rotation speed is at least at 50% of an initiation rotational speed of a first natural bending vibration of the shaft (4) having just first and second main bearings (6, 7).

The invention concerns an electro dynamic engine with a rotatably supported shaft, as well as the use of a third bearing as a support and for an increase of the rotational speed of a shaft which is supported by means of just two main bearings.

Electro dynamic engines are known in different designs and embodiments. They can be designed, for instance, as electric motors or electric generators. These engines each comprise a shaft which is usually rotatably supported by two bearings.

For instance, DE 10 2007 057 034 A1 describes a hand tool engine with an electric drive motor and a shaft which is supported by means of two bearing zones. Such hand tool engines are, due to their special design and purpose of use, only applicable for shafts of comparably lower rotational speeds. In particular, these engines are operated significantly below the rotational speeds where a first natural bending frequency would occur.

DE 10 2005 035 834 A1 describes another electric motor with a rotatable shaft supported by bearings. In this motor, three bearing points are provided for the shaft, one eccentric bearing is disposed between the two main bearings for wear reduction. Also the shaft of this electro-hydraulic aggregate is only operated at comparably, lower rotational speeds which are significantly lower than where the critical bending frequency range resides.

It is therefore the task of the invention to present an electro dynamic engine as in the above described art which has a shaft that can be operated at a high speed of rotation.

To solve the task, an electro dynamic engine is presented in accordance with the characteristics of claim 1. The electro dynamic engine with a rotatably mounted shaft having two main bearings, that are axially spaced from another, and are provided to support the shaft. In addition, a third bearing is provided, which can absorb the radial force generated by the shaft. Hereby is provided, a design for the maximum rotational speed of the shaft. The maximum rotational speed is at least 50% of the rotational speed which is needed to create the natural bending frequency, compared to a shaft which is rotatably supported by just two main bearings.

An electro dynamic engine can be an electric motor or an electric generator. The shaft is positioned in a centered, longitudinal axis, which is in particular also the rotation axis of the shaft. Here in this case, the used positioning nomenclature “axial” and “radial” relates to this central, longitudinal axis. Hereby, “axial” means an orientation in parallel to the central, longitudinal axis, and “radial” means a direction perpendicular to the central, longitudinal axis. The electro dynamic engine comprises additional components, such as for instance the actual and electro dynamically operating active unit with a stator and a rotor which is positioned on the shaft, which is at least magnetically coupled during the operation with the stator. Hereby, the active unit is especially positioned between the two main bearings.

It has been recognized that, due to the application of a third bearing, the maximum rotational speed in which the shaft can be operated can be significantly increased. This is especially important at high speed rotation, meaning a very fast rotating electro dynamic engine. Such a high rotational speed engine can especially be assumed if the maximum rotational speed exceeds more than 50% of the rotational speed of a first natural bending frequency. In addition or as an alternative, the construction of a high-speed rotational engine can also relate to the circumferential speed of the shaft. The maximum rotational speed of the shaft for which the electro dynamic engine is specified, has its dimensions calculated in particular in an area of the shaft with the smallest outer shaft diameter, so that a circumferential surface of the shaft, when at the maximum rotational speed of the shaft, a circumferential speed of at least 100 m/sec exists. Hereby, this speed condition applies especially to any partial element of the outer circumferential surface of the shaft in the area with the smallest outer diameter of the shaft.

Due to the third bearing, the unwanted creation of a first natural bending frequency has been made more difficult, or at least moved to an area where the shaft rotational speed is larger. Hereby, the third bearing is specified in a way so that it can absorb radial forces which are created by the shaft, for instance during the initiation of the first natural bending frequency. Especially due to the absorption of these radial forces to the third bearing, the mentioned suppression of the natural bending frequency is accomplished, or a shifting to significantly larger rotational speeds. Thus, the shaft can also be operated without any problems, and especially without the natural bending frequency, in a higher rotational speed range, where to the contrary, and without the third supporting bearing, meaning the exclusive support by means of both main bearings, the natural bending frequency would have taken place already or could have happened at a high probability.

Thus, the application of a third bearing allows an operation of the electro dynamic engine at a significantly larger maximum rotational speed of the shaft. The third bearing represents a dynamic guide of the shaft.

Advantageous embodiments of the electro dynamic engine are part of the characteristics in the dependent claims which are based on claim 1.

Favorable is an embodiment where an axial distance of the two main bearings is provided, and where the third bearing has an axial distance to one of the two main bearings which is at most 50% of the main bearing distance. If the auxiliary bearing distance with its dimension is in this named range, many different applications can be covered. A short auxiliary bearing distance results in a shorter, overall construction length of the electro dynamic engine, whereby a longer auxiliary bearing distance allows the dimensioning for a lower radial force absorption and thus, dimensions of components with lower masses.

Favorable is an additional embodiment in which the auxiliary bearing distance is 50% of the main bearing distance. Hereby, the third bearing is exactly in the axial position at which, in the case of exclusive two-position bearings by means of the two main bearings, a first natural bending frequency would cause a maximum amount of radial deflection. Therefore, this location is favorable for the positioning of the third bearing. Hereby and compared with other, basically possible axial positions for the third bearing, lower radial forces which have to be absorbed, will occur.

In accordance with an additional, favorable embodiment, the auxiliary bearing distance is at most 40%, in particular at most 25%, and preferably at most 10% of the main bearing distance. The closer the third bearing is positioned to the neighboring main bearing, the smaller the overall resulting construction length of the electro dynamic engine will be.

Favorable is another embodiment in which the axial bearing distance of the third bearing, in relationship to one of the two main bearings, is in the range between 25% and 75%, in particular between 40% and 60%, and preferably between 45% and 55% of the main bearing distance between the two main bearings. In view of the radial force absorption, the auxiliary bearing distance of 50% of the main bearing distance, is a turning point. At this position, the maximum shaft deflection is present and thus the minimum radial force. On both sides of this extreme position, the related values change equally, so that the third bearing, in comparison to the highlighted position of 50%, can be positioned at a larger and a smaller main bearing distance. Hereby, the position can be selected in relationship to the remaining, neighboring conditions of the respective embodiments of the electro dynamic engine.

In a favorable additional embodiment, the third bearing is positioned at a side of one of the two main bearings, which is facing away from one of the two main bearings. Therefore, the third bearing is especially not positioned between the two main bearings, but outside of the area which is enclosed by the two main bearings. In this enclosed area, another component of the electro dynamic engine, for instance the electro dynamic, effective active unit with the rotor and the stator, can here be positioned, so that there is no possibility for a placement of the third bearing.

Favorable is an additional embodiment in which the third bearing is designed as a planetary transmission or as a planetary set. Such a planetary transmission or planetary set, for instance, is on one side and the position to absorb a radial force, which is caused by the shaft, takes the torque off the shaft without any radial force so that the shaft, in particular, does not experience any additional stress. Furthermore, there is no significant bending stress or creation of imbalance when the third bearing is designed as a planetary transmission or planetary set.

It is also favorable when the electro dynamic engine is designed as a traction drive. Such engines are often used when the shaft rotational speed significantly varies. In particular, a larger maximum rotational speed is desired in such traction drives. The latter can be achieved through the supporting third bearing which also allows an increase of the rotational speed.

An additional, advantageous aspect of the invention is the fact of the special application of a third bearing for the support and the increase of the applicable rotational speed in the bearing of a shaft, which is already supported by means of two main bearings. Through the third bearing, the initiation rotational speed causing the first natural bending vibration of the shaft is increased so that the shaft, altogether, can be operated with a very large maximum rotational speed. This maximum rotational speed is at least 50% of the excitation rotational speed at which the first natural bending vibration is created at the shaft. This excitation rotational speed is hereby not related to a three-point bearing shaft, but to a two-point bearing shaft, meaning a shaft which is supported exclusively through the two main bearings. Through this application of a third bearing, the same characteristics and advantages arise as already explained and described earlier for the electro dynamic engine and its embodiments. Also, respective embodiments for an application of a third bearing are possible for of the electro dynamic engine as previously described.

Additional characteristics, advantages, and details of the invention are presented in the following description of embodiments based on the content of the drawings. It shows:

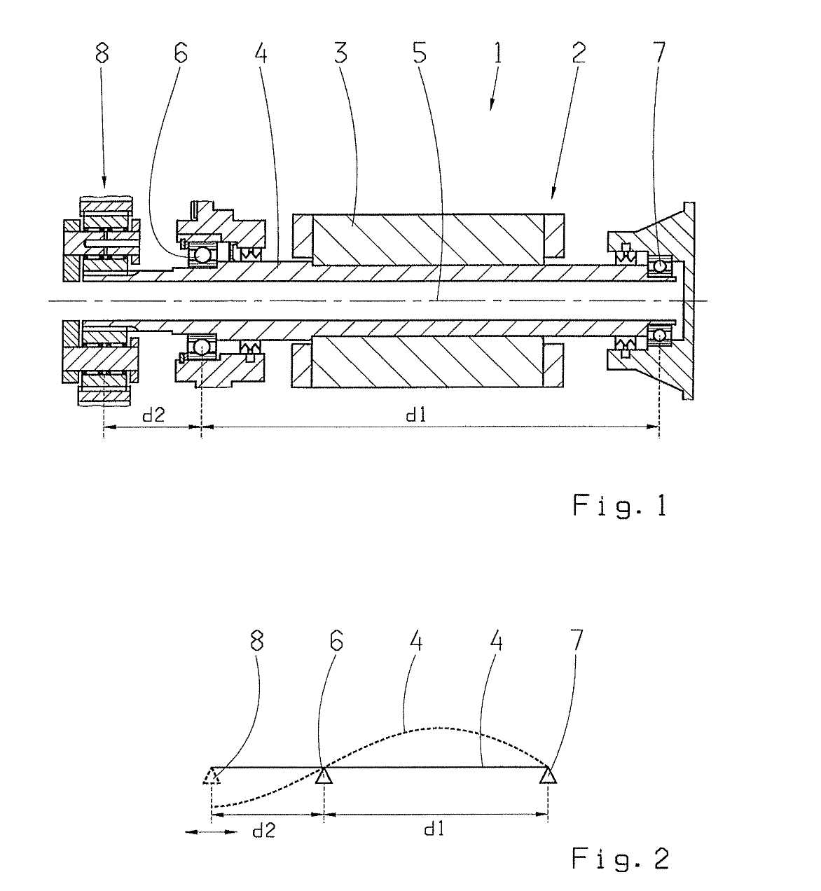

FIG. 1 an embodiment of an electro dynamic engine with a three-point bearing shaft, and

FIG. 2 the shaft in accordance with FIG. 1 with a two-point bearing in an idle condition and in an excited, first natural bending frequency, each in schematic form.

The same related parts in FIGS. 1 and 2 are provided with the same reference characters. Also details in the following, furthermore explained embodiments can be an invention by itself or it can be part of an invented matter.

FIG. 1 shows a sectional view of an embodiment of an electro dynamic engine 1 which is designed as an electric motor. The electro dynamic engine 1 comprises an active unit 2 of which only the rotor 3 shown, in the section view. The stator of the active unit 2 is not illustrated. As known in the art, the rotor 3 and the not shown stator are separated by an air gap and magnetically coupled during operation across the air gap. The rotor 3 is connected in a rotationally fixed manner to a shaft 4 having a central longitudinal axis 5 and which rotates around the central longitudinal axis 5 by means of a bearing. Therefore, the central longitudinal axis 5 is the rotational axis of the shaft 4 and also of the electric motor. In the embodiment shown in FIG. 1, the shaft 4 is designed as a hollow shaft. However, other embodiments are also generally possible, such as a solid shaft.

As bearings for the shaft 4, two main bearings 6 and 7 are provided which are positioned on both sides of the active unit 2. Although the main bearings 6 and 7 are presented in the embodiment as ball bearings, other bearing types such as roller bearings designed as a cylinder, needle, or cone roller bearings, or also as slide bearings, can also apply.

Axially, on the side next to the main bearing 6, a planetary transmission 8 is positioned, which is designed to absorb on one hand the torque on the shaft 4, and on the other hand is designed to provide additional support for the shaft 4. Thus, the shaft 4 is provided with a three-point bearing. The two main bearings 6 and 7 form the primary bearing locations, while the planetary transmission 8 functions as a supportive bearing and is also a dynamic guide of the shaft 4.

The two main bearings 6 and 7 are arranged with respect to each other at a main bearing distance d1. The planetary gear 8 is axially spaced at an auxiliary bearing distance d2 from the main bearing 6 and it is positioned on the side of the main bearing 6 which is opposite from the main bearing 7.

Due to the planetary gear 8, the maximum rotational speed of the electro dynamic engine 1 can be increased, without causing unwanted natural bending vibration of the shaft 4. In fact, the planetary gear 8 can absorb radial forces which are created by the shaft 4 and can therefore contribute to the damping of natural bending vibration.

This effect is further explained in the following through the FIG. 2. In the schematic presentation in accordance with FIG. 2, the shaft 4 is presented just as a line. Also the main bearings 6 and 7 are, as well as the planetary transmission 8, presented in a schematic format as bearing locations, wherein the planetary transmission 8 is first omitted in the following considerations. Thus, the planetary transmission 8 is represented in the drawing, in accordance with FIG. 2, shown as a dotted line. The shaft 4, in its idle condition or at a non-critical rotational speed, is shown as a straight, continuous line. At a certain rotational speed, which is also called the critical rotational speed, a first natural bending vibration is initiated in the shaft 4. The deflection profile is also shown essentially in FIG. 2 as a dotted sine wave line. One can recognize the effect of the main bearings 6 and 7 as fixing points, in reference to a radial deflection. The radial position of the shaft 4 can be maintained, also at an initiated, first natural bending vibration, due to the main bearing 6 and 7. To the contrary, at the location at which the planetary transmission 8 is positioned, the radial deflection of the shaft 4 would occur. Such a deflection would be suppressed by the planetary transmission 8, therefore, the unwanted creation of the bending mode self oscillation would not occur already at this particular rotational speed. Thus, the shaft 4 can be operated at that rotational speed which would lead, without the additional guide and support function of the planetary transmission 8, to a critical operating condition.

The size of the radial deflection at the positioning of the planetary transmission 8 and also the strengths of the radial forces which have to be absorbed by the planetary transmission 8 depends on the axial location at which the planetary transmission 8 is positioned, meaning depending on the auxiliary bearing distance d2. In the shown drawing, in accordance with FIG. 2, the planetary transmission 8 is exactly positioned where the maximum amplitude of the first bending mode vibration occurs. Therefore and at this point, a bearing configuration by means of the two main bearings 6 and 7 would cause a maximum radial deflection. The auxiliary bearing distance d2 is hereby just one half of the main bearing distance d1.

Basically, other axial positions for the planetary transmission 8 are also possible. The closer the planetary transmission 8 moves towards the main bearing 6, the larger are the radial forces which have to be absorbed by the planetary transmission 8. On the other hand, the construction length of the electro dynamic engine 1 decreases.

Thus, the application of the planetary transmission 8 enables an increase of the bending stiffness of the shaft 4 and therefore causes an increase of the bending critical initiating rotational speed for the first natural bending vibration. Hereby, the maximum rotational speed of the shaft 4 can be increased. It is especially of interest for high rotational speed applications, such as for instance in a traction drive.

### REFERENCE CHARACTERS

1 Electro dynamic Engine
2 Active Unit
3 Rotor
4 Shaft
5 Centered longitude axis
6 Main bearing
7 Main bearing
8 Planetary gear
d1 Main bearing distance
d2 Auxiliary bearing distance

1-9. (canceled)

10. An electro dynamic engine with a rotatable, positioned shaft (4), the shaft (4) being supported by first and second main bearings (6, 7) which are axially spaced from one another,
an additional third bearing (8) being designed for at least absorbing radial forces which are generated by the shaft (4), and
the third bearing (8) supporting the shaft (8) at a location along the shaft (8) for establishing a maximum rotational speed of the shaft (4) and the maximum rotational speed being at least 50% of a rotational speed at which a first natural bending vibration of the shaft (4) having only the first and the second main bearings (6, 7) occurs.

11. The electro dynamic engine according to claim 10, wherein the first and the second main bearings (6, 7) are axially spaced from one another along the shaft (4) by an axial main bearing distance (d1), and the third bearing (8) is axially spaced along the shaft (4) from the first main bearing (6) by an auxiliary bearing distance (d2), and the auxiliary bearing distance (d2) is at most 50% of the main bearing distance (d1).

12. The electro dynamic engine according to claim 11, wherein the auxiliary bearing distance (d2) is 50% of the main bearing distance (d1).

13. The electro dynamic machine according to claim 11, wherein the auxiliary bearing distance (d2) is at the most 10% of the main bearing distance (d1).

14. The electro dynamic machine according to claim 10, wherein the first and the second main bearings (6, 7) are axially spaced from one another along the shaft (4) by an axial main bearing distance (d1), and the third bearing (8) is axially spaced along the shaft (4) from the first main bearing (6) by an auxiliary bearing distance (d2), and the auxiliary bearing distance (d2) is between a range of 25% and 75% of the main bearing distance (d1).

15. The electro dynamic machine according to claim 10, wherein the third bearing (8) is positioned on a side of the first main bearing (6), the side of the first main bearing (6) is located opposite from the second main bearing (7).

16. The electro dynamic machine according to claim 10, wherein the third bearing is a planetary transmission (8).

17. The electro dynamic machine according to claim 10, wherein the electro dynamic machine is a traction drive.

18. An application of a third bearing (8) as a support and as a bearing for increasing a rotational speed of a shaft (4) which has first and second main bearings (6, 7),
an initiation rotational speed of a first bending mode self oscillation of the shaft (4) being increased by the third bearing (8) such that the shaft (4) being operable with a maximum rotational speed which is at least 50% of the initiation rotation speed, at which the first bending mode self oscillation is initiated when the shaft (4) has only the first and second main bearings (6, 7).

19. An electro dynamic engine comprising:
a rotor being supported by a rotatable shaft,
the shaft being supported by first and second main bearings, which are axially spaced from one another,
the rotor being located axially between the first and the second main bearings, and
an additional third bearing for at least absorbing radial forces which are generated by rotation of the shaft,
the third bearing supporting the shaft at an axial location that is on an axial side of the first main bearing that is opposite from the rotor and the second main bearing, and
the third bearing being axially spaced from the first main bearing by a distance that is approximately 50% of an axial distance between the first and the second main bearings.

20. The electro dynamic machine according to claim 19, wherein the first and the second main bearings are axially spaced from one another along the shaft by an axial main bearing distance and the third bearing is axially spaced along the shaft from the first main bearing by an auxiliary bearing distance, and the auxiliary bearing distance is between a range of 25% and 75% of the main bearing distance.

21. The electro dynamic machine according to claim 19, wherein the third bearing is positioned on a side of the first main bearing, the side of the first main bearing is located opposite from the second main bearing.

22. The electro dynamic machine according to claim 10, wherein the third bearing is a planetary transmission.

23. The electro dynamic machine according to claim 19, wherein the first and the second main bearings are axially spaced from one another along the shaft by an axial main bearing distance and the third bearing is axially spaced along the shaft from the first main bearing by an auxiliary bearing distance, and the auxiliary bearing distance is between a range of 25% and 75% of the main bearing distance,
the third bearing is positioned on a side of the first main bearing, the side of the first main bearing is located opposite from the second main bearing, and
the third bearing is a planetary transmission.
